(19) United States
(12) Patent Application Publication
(10) Pub. No.: US 2010/0193719 A1
(43) Pub. Date: Aug. 5, 2010

(54) DEVICE AND METHOD FOR CONTROLLING AN ELECTROMAGNETIC VALVE

(76) Inventor: Axel Bartel, Fellbach (DE)

Correspondence Address: KENYON & KENYON LLP, ONE BROADWAY, NEW YORK, NY, 10004, US

(21) Appl. No.: 12/448,904

(22) PCT Filed: Jan. 14, 2008
(86) PCT No.: PCT/EP2008/050331

§ 371 Date: Mar. 3, 2010

(30) Foreign Application Priority Data
Jan. 22, 2007 (DE) 10 2007 003 211.2

(51) Int. Cl. F16K 31/02

(52) U.S. Cl. 251/129.01

(57) ABSTRACT

A device and a method for controlling an electromagnetic valve. A valve needle of an electromagnetic valve takes up a first position if no current is applied to it and a second position if a current is applied to it. During the transition from the second position to the first position of the valve needle, an after-current application takes place beginning at a specifiable point in time and for a specific period of time.

### BACKGROUND INFORMATION

The present invention relates to a method or a device according to the species defined in the main claims.

A method and a device are known from DE 38 43 138 for controlling and recording the motion of an armature of an electromagnetic switching process. In that document, the time is detected at which the armature reaches its new final position, by evaluating the current that is flowing through the consumer. This is no problem when the consumer is switched on, since a current is flowing at this point, as a rule, and an evaluation is possible. At the time of switching off, it happens, as a rule, that the current has already dropped down to zero when the armature reaches its new end position. In this case, an evaluation of the current for the detection of the switching time is no longer possible.

Furthermore, the following type of problem occurs in the case of such electromagnetic valves. In order to achieve a rapid switching of the valve, it is usually provided that a rapid discharge take place. This results in the valve needle striking its seat at great speed. In the long run, this rapid striking leads to an erosion in the seat, and, with that, to inaccuracy of the injection.

### DISCLOSURE OF THE PRESENT INVENTION

### Advantages of the Present Invention

By contrast, the device according to the present invention and the method according to the present invention, having the features of the independent claims, have the advantage that the valve needle is braked before reaching the seat, with the switching time not changing substantially, at the same time. Furthermore, the switching time may in addition be obtained as a further measuring variable.

This is achieved, according to the present invention, in that, in the transition of the valve needle from its second position into the first position, beginning at a specifiable point in time, an after-current flows for a specific period of time. In this context, the valve needle takes up the second position in the state in which it is supplied with current, and the first position in the state in which it is not supplied with current.

This means that, for a certain time period before reaching the seat, the valve has a supply voltage applied to it. In this context, the beginning of this activation is selected as a function of the point in time of reaching the seat.

In one embodiment according to the present invention, the duration of this activation is selected so that the needle is braked and, at the same time as the switching time, a current is still flowing. This has the advantage that the braking effect is attained and the switching time is detectable. The switching time is required, in this instance, for the activation as a response to the next injection, or rather the next activation, in order to establish the point in time of applying the after-current. Furthermore, this switching time is also available for additional methods and devices, for controlling the internal combustion engine. Thus, for instance, one may use the switching time to check whether the valve is switching at the correct time.

### BRIEF DESCRIPTION OF THE DRAWINGS

Exemplary embodiments of the present invention are shown in the drawings and are explained in greater detail in the following description. The figures show:

FIG. 1 the essential elements of the device according to the present invention, shown as a block diagram,

FIG. 2 various signals plotted over time and

FIG. 3 a flow chart of the procedure according to the present invention.

### SPECIFIC EMBODIMENTS OF THE PRESENT INVENTION

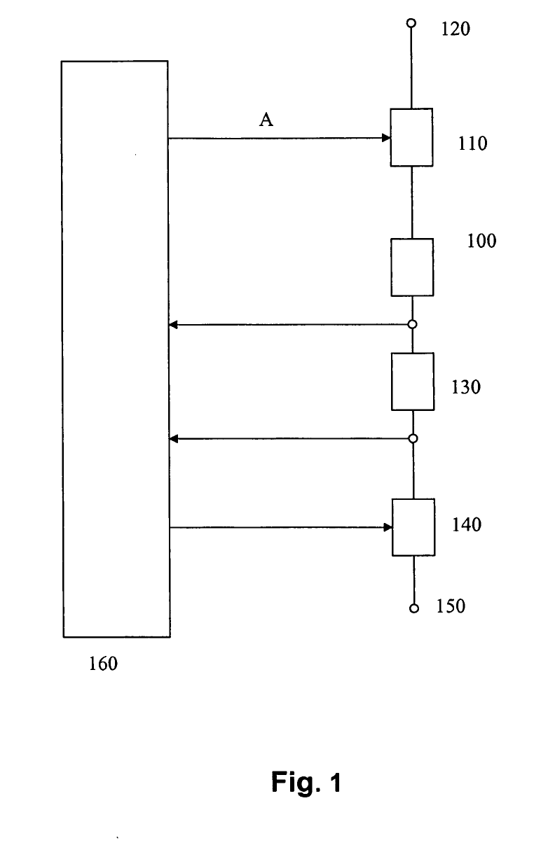

The essential elements of a device for controlling an electromagnetic valve are shown with the aid of a block diagram in FIG. 1. The electromagnetic valve is identified by 100. This is connected to a first terminal 120 of a supply voltage via a first switching element 110. Moreover, a second terminal of electromagnetic valve 100 is connected to a second terminal 150 of the supply voltage via a current measuring device 130 and a second switching element 140.

First switching element 110 receives triggering signal A from a control unit 160. Second switching element 140 also receives triggering signal A from a control unit 160. Furthermore, the voltage drop over a current measuring device 130, which is preferably developed as a resistor, is picked off by the control unit and evaluated by control unit 160.

The arrangement of first switching element 110, second switching element 140 of electromagnetic valve 100 and of current measuring device 130 are only shown in exemplary fashion. Thus, in one embodiment, it may also be provided that additional switching elements are provided or that the only one switching element is provided. Furthermore, current measuring device 130 may be positioned at any other position in the circuit. The first and the second switching element may also be exchanged.

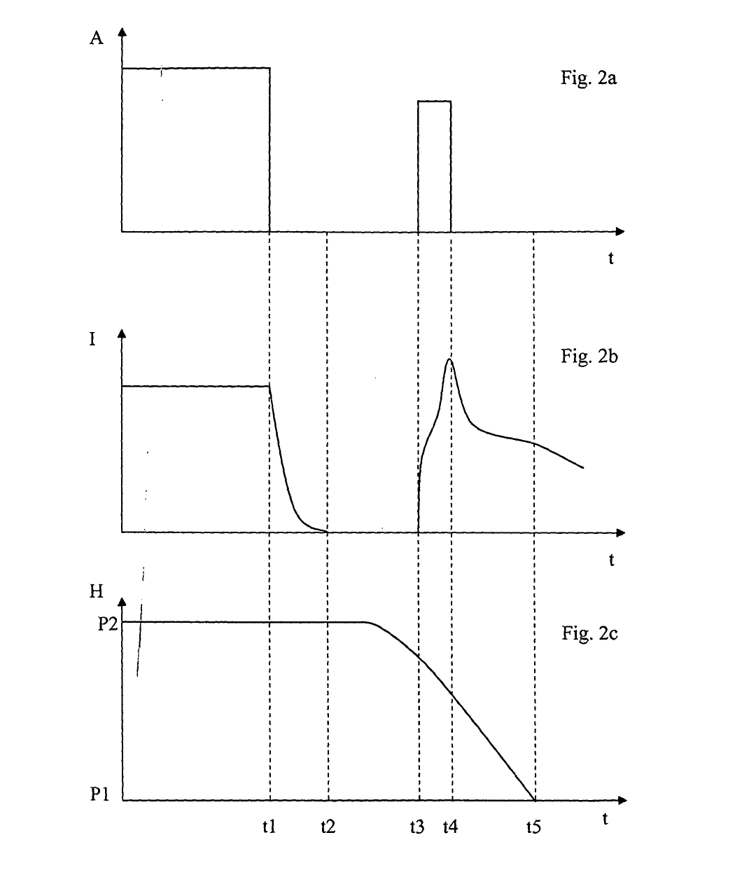

Starting from input signals that are not shown, the control unit calculates the beginning and the end of the activation of the first switching element. At the beginning of the activation, the current through the electromagnetic valve rises, and after the end of the activation, at time t₁, it drops off to zero again. In the following, the activation at the end of the activation process is described in greater detail with the aid of FIG. 2. In FIG. 2a, activation signal A is plotted against time t. In FIG. 2, the current flowing through the electromagnetic valve is plotted against time t. In FIG. 2c, the lift of the valve needle of the electromagnetic valve is plotted against time t. The graphs shown are only exemplary, and are qualitative illustrations which take on different curves in response to different valve types.

As long as the electromagnetic valve is supplied with current, the valve needle takes on a second position P2. If the valve is not supplied with current, the valve needle takes up a first position P1. Since the valve needle has a certain mechanical inertia, and since various electromagnetic and also hydraulic effects act on it, the transition between the first position and the second position, or vice versa, does not take place abruptly but gradually.

In the following, we shall look at the transition from the second position to the first position, in greater detail. This transition is particularly problematical since, in this case, the valve needle strikes the seat of the valve in order to close the valve. At time t1, activation A ends, and the current begins to drop off towards zero beginning at time t1. Based on a delay in the magnetic decay owing to eddy currents, the valve needle still remains in its position. At time t2, current I reaches the value zero. At this time, the valve needle has moved away from its second position only slightly, if at all. At time t5, the valve needle reaches its first position and strikes its seat.

Now, according to the present invention, it is provided that, between time t3 and t4, first switching element 110 is activated again. The result is that the current rises again, and subsequently drops off again. In this context it is preferably provided that, in response to the dropoff, no rapid discharge takes place but that the current drops off slowly.

Time t3, at which the current supply begins, is specified as a function of time t5, in this instance. Since time t5 is not yet known at time t3, time t5, that is, the closing time of the valve, is ascertained during the preceding metering or during the preceding activation of the corresponding consumer.

The duration of the activation, that is, the time between time t3 and time t4, is selected in such a way that it ends before switching time t5, the needle is braked, and at time t5 there is still a current flowing.

The duration of activation is preferably the same for one type of valves, and is stored as a constant value in the control unit. In one embodiment it may also be provided that this value be selected as a function of the operating state of the internal combustion engine and/or environmental conditions.

The time between time t4 and t5, that is, between the end of the valve's having current supplied to it and reaching its new end position is also preferably stored as a fixed value for the magnetic valve.

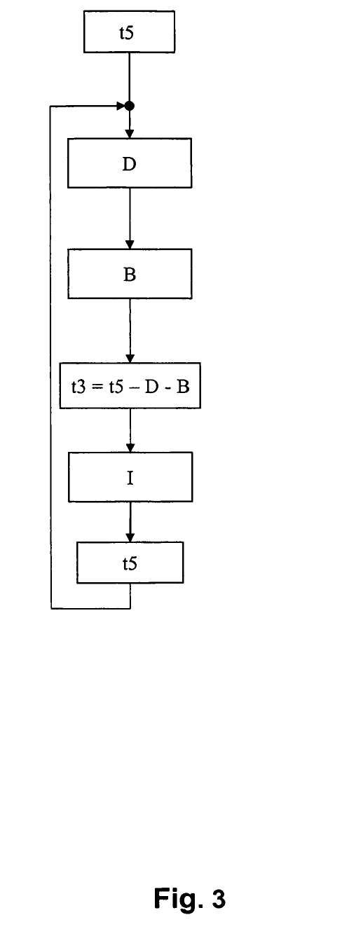

The procedure according to the present invention is represented in FIG. 3 with the aid of a flow chart. In a first step 300, the method is initiated by switching on the internal combustion engine. For this purpose, a starting value is preferably specified for time t5. In step 310, period of time D of the activation for after-current application is read out of a memory. This period of time determines the time between times t3 and t4. In subsequent step 320, distance in time B between after-current application and switching time, that is, the time between times t4 and t5 is read out from a memory. In a subsequent step 330, the beginning of supplying current, that is, time t3 starting from time t5, period of time D of supplying current and time B between the end of supplying current and the switching time according to the formula t₃=t₅−D−B are specified. Subsequently, in step 340, applying current takes place beginning at time t3 for the duration D, that is, to time t4. In step 350 the current curve is subsequently evaluated and time t5 is ascertained, at which the valve needle impacts. After that, step 310 takes place again.

The period of time D of the after-current application and time B of the after-current application from switching point t5 are usually specified for a valve in a fixed manner, and stored in a memory. In one particularly advantageous embodiment it may, however, also be provided that these quantities be specified starting from operating characteristic variables of the internal combustion engine and/or from environmental variables. The period of time D of the after-current application is selected in such a way that it effects a braking force on the valve needle. In this context, the distance in time B, between the after-current application and the switching time is selected so that, at the switching time, an easily measurable current is flowing.

If period of time D is picked to be too short, the case may occur in which the closing process is delayed, and the switching time of the magnetic valve changes significantly. If period of time D is picked to be too short, the braking effect of the after-current application does not take place, and the valve needle strikes its seat at high speed, and this leads to an increased erosion on the valve seat.

Distance in time B is specified in such a way that, at switching time t5 a current is still flowing, which makes it possible to evaluate the point in time of switching. If period of time D is picked to be too great, the case may also occur in which the closing process is delayed, and the switching time of the magnetic valve changes significantly.

Different current curves are usually employed in applying current to magnetic valves. The procedure according to the present invention is applicable for all current curves. In the activation of magnetic valves, the distinction is usually made between a pickup-current and a holding-current application. It is preferably provided that, for the after-current application, the valve should have the usual activation applied to it for the pickup current activation.

1-5. (canceled)

6. A method for controlling an electromagnetic valve, comprising:
situating a valve needle of the electromagnetic valve in a first position if no current is applied to it, and in a second position if current is applied to it; and
in response to a transition from the second position to the first position of the valve needle, beginning at a predetermined point in time, carrying out an application of an after-current for a predetermined period of time.

7. The method according to claim 6, wherein the predetermined point in time, at which the application of the after-current begins, is specified starting from a switching time, at which a consumer reaches its first position.

8. The method according to claim 6, wherein the period of time of the after-current application is selected in such a way that a braking force acts on the valve needle.

9. The method according to claim 6, wherein a distance in time between the after-current application and a time at which a consumer reaches its first position is specified in such a way that, at the time at which the consumer reaches its first position, a current is flowing through the consumer, the distance in time assuming a value greater than zero.

10. A device for controlling an electromagnetic valve, the electromagnetic valve including a valve needle situated in a first position if no current is applied to it and in a second position if a current is applied to it, the device comprising:
means for carrying out an after-current application in response to a transition from the second position to the first position of the valve needle, beginning at a predetermined point in time and for a predetermined period of time.
